(19) United States
(12) Patent Application Publication
(10) Pub. No.: US 2011/0167041 A1
(43) Pub. Date: Jul. 7, 2011

(54) METHOD AND DEVICE FOR MAINTAINING A CHANGELOG IN DATA SYNCHRONIZATION

(75) Inventors: Liqin Fu, Guangdong Province (CN); Tao Zhou, Guangdong Province (CN); Jingchun Pu, Guangdong Province (CN); Fei Ju, Guangdong Province (CN); Xin Xie, Guangdong Province (CN); Lei Yuan, Guangdong Province (CN)

(73) Assignee: ZTE Corporation, Guangdong Province (CN)

(21) Appl. No.: 13/062,941

(22) PCT Filed: Dec. 30, 2008
(86) PCT No.: PCT/CN2008/073860

§ 371 Date: Mar. 8, 2011

(30) Foreign Application Priority Data
Sep. 9, 2008 (CN) 200810160881.8

(51) Int. Cl. G06F 17/30

(52) U.S. Cl. 707/634; 707/E17.005

(57) ABSTRACT

A method and device for maintaining a changelog in data synchronization are provided in the present invention, in which the changelog is configured to record an operation executed for an object and is composed of data record items. The data record item includes flag information configured to uniquely identify an object and an operation type corresponding to the flag information, the operation type includes adding, updating and deleting. The method includes: reading, between two times of the data synchronization, flag information of a first data record item which is required to be added to the changelog; searching for whether there is a second data record item including the flag information in the changelog, and in a situation that there is the second data record item, setting the second data record item according to the first data record item. By the present invention, the changelog file can be prevented from continuously increasing.

### FIELD OF THE INVENTION

The present invention relates to the mobile communication field, and in particular, to a method and device for maintaining a changelog in the data synchronization.

### BACKGROUND OF THE INVENTION

Currently, the resources such as personal information, schedule information and mail information in the mobile terminal have become an important part in the information management of the mobile terminal. The problem of how to safely and effectively back up the data into the network server so as to make it easy to recover the data backed up when the mobile terminal such as mobile phone is replaced or the data in the mobile terminal is changed has become one subject in the data synchronization research, wherein SyncML (Synchronous Markable Language) protocol can realize the data synchronization of the mobile terminal with the network server.

Suppose that a SyncML account number is registered on a certain network server for the mobile phone card in the mobile phone, for instance, SIM (Subscriber Identity Model) card or USIM (Universal Subscriber Identity Model) card, when the data information in the mobile phone changes, the user can directly use the SyncML application in the mobile phone for the data synchronization to keep the mobile phone terminal data consistent with the server data.

At present, the basic data synchronization type includes bidirectional fast synchronization and bidirectional slow synchronization, wherein with the bidirectional slow synchronization, all the data record items (such as contacts and calendar) on the mobile terminal and network server are synchronized; and with the bidirectional fast synchronization, all changes occurring in the mobile terminal and network server since the last synchronization of the mobile terminal with network server are synchronized. The user who has registered the SyncML protocol service can select one of the above types to perform data synchronization for the data between the mobile terminal and network server so as to finally keep the data on the mobile terminal and server consistent.

In the above, as for the bidirectional fast synchronization which aims at exchanging the change information, there exists a problem of designing the changelog. The changelog is used to record the data change information in the mobile terminal or network server (either of the two) since the last synchronization. The change information appears in the form of data record items and includes contents of two parts: object and operation for the object, wherein the operation for the object is classified into three types: adding (ADD), deleting (DELETE) and updating (UPDATE), i.e. the changelog records the specific modification to a certain record.

FIG. 1 is a data structure scheme of the changelog in a mobile terminal such as mobile phone in the prior art. As shown in FIG. 1, this changelog includes two data items: the operated object and the operation for this object. The operated object herein refers to the unique ID (Identifier) number, recorded in the database, of each piece of information stored in the mobile phone.

In the SyncML protocol, the unique ID number of the database record is called as Locally Unique Identifier (LUID for short). This LUID is generated in the mobile phone and is unique; at the mobile phone side, even if data of record item added is identical with a certain deleted record, the LUID of the data of record item added is still different from the LUID of the record formerly deleted.

FIG. 2 is a scheme of a specific example of the changelog as shown in FIG. 1. As shown in FIG. 2, the following operations are performed for the object, respectively: performing an ADD operation for the record of which LUID is 10, a DELETE operation for the record of which LUID is 5, and UPDATE and DELETE operations for the records of which the LUIDs are 6 and 7, respectively.

Based on the provisions of the SyncML protocol, there exist the following problems:

(1) Between two times of synchronization, if a plurality of times of operations are performed for a certain record, each time of the operation then will be recorded into the changelog file. In fact, only the final modification of the record is valid; correspondingly in the changelog file, only the final record is meaningful. Therefore, the redundant data will be produced in the changelog file based on the provisions of the SyncML protocol; and

(2) After a certain piece of changed information stored in the mobile phone has been successfully synchronized to the network side, this record item is still recorded in the changelog file. In fact, the data in this record item is invalid. and thereby causing the redundant data present in the changelog file.

Due to the two reasons, the changelog file continuously increases as it includes a lot of invalid redundant data thus occupy more and more memory spaces.

### SUMMARY OF THE INVENTION

The present invention is made by considering the problem that the changelog file continuously increases as it includes a lot of invalid redundant data so as to occupy more and more memory spaces in the related art, thus the object of the present invention is to provide a method and device for maintaining a changelog in data synchronization for solving the above problem.

In order to achieve the above object, a method for maintaining a changelog in data synchronization is provided according to one aspect of the present invention.

In the method for maintaining a changelog in data synchronization according to the present invention, the changelog is configured to record an operation executed for an object and is composed of data record items, wherein the data record item includes flag information configured to uniquely identify an object and an operation type corresponding to the flag information, and the operation type includes adding, updating and deleting. The method includes: between two times of the data synchronization, for a first data record item which is required to be added to the changelog, reading its flag information; searching for whether there is a second data record item including the flag information in the changelog, and in a situation that there is the second data record item, setting the second data record item according to the first data record item.

Preferably, the step of setting the second data record item according to the first data record item specifically includes: in a situation that the operation corresponding to the first data record item is deleting, if the operation type included by the second data record item is adding, deleting the second data record item, and if the operation type included by the second data record item is updating, setting the operation type of the second data record item to be deleting; and in a situation that the operation corresponding to the first data record item is updating, the operation type included by the second data record item remaining unchanged.

Preferably, in a situation that there is no second data record item, the first record item is added to the changelog, and the operation type is set according to the operation corresponding to the first data record item.

Preferably, the data record item further includes a flag code, wherein the flag code is configured to identify whether the data record item is valid or not.

Preferably, the flag code identifies invalid according to at least either of the following two situations: the operation corresponding to the first data record item causes the second data record item to be invalid; and the synchronization process of the data record items in the changelog is completed.

Preferably, the situation of the operation corresponding to the first data record item causing the second data record item to be invalid specifically includes: the operation corresponding to the first data record item being deleting, and the operation type included by the second data record item being adding.

Preferably, after the second data record item is set according to the first data record item, the above method further includes: storing the data record item identified by the flag code to be valid as new changelog; and replacing the changelog with the new changelog.

Preferably, the changelog is set at the mobile terminal side or network side.

Preferably, in a situation that the changelog is set at the mobile terminal side, the above method further includes: after the mobile terminal and network side complete the data synchronization by means of the changelog, the mobile terminal deleting all data record items in the changelog.

In order to achieve the above object, a device for maintaining a changelog in data synchronization is provided according to the other aspect of the present invention.

In the device for maintaining a changelog in data synchronization according to the present invention, the changelog is configured to record an operation executed for an object and is composed of data record items, wherein the data record item includes flag information used to uniquely identify the object and an operation type corresponding to the flag information, the operation type includes adding, updating and deleting. The device comprises: a reading module, configured to, for a first data record item which is required to be added to the changelog, read flag information of the first data record item between two times of the data synchronization; a searching module, configured to search for whether there is a second data record item including the flag information in the changelog; and a setting module, configured to set the second data record item according to the first data record item in a situation that the searching result by the searching module is that there is the second data record item.

Preferably, the device further comprises a deleting module, configured to delete all data record items for which the data synchronization has been performed in the changelog.

With at least one technical solution described above in the present invention, regarding the problem that there is redundant data in the changelog file as a certain piece of information stored in the mobile phone terminal is modified time after time between two times of synchronization, only the changed information in the last time is stored with the technical means of overlapping the latter data record items in the changelog over the former data record items so as to prevent the changelog file from continuously increasing.

### BRIEF DESCRIPTION OF THE DRAWINGS

The drawings here provide a further understanding of the present invention, form a part of the present application, and explain the present invention together with the embodiments in the present invention without unduly limiting the scope of the present invention, wherein

FIG. 1 is a changelog data structure scheme in a mobile terminal such as mobile phone in the prior art;

FIG. 2 is a scheme of a specific example according to the changelog data structure scheme as shown in FIG. 1;

FIG. 3 is a structure block diagram of a device for maintaining a changelog in data synchronization according to the embodiments in the present invention;

FIG. 4 is a flow chart of a method for maintaining a changelog in data synchronization according to the embodiments in the present invention;

FIG. 5 is a schematic diagram of information changes in corresponding changelog when the same data record item is modified between two times of synchronization, according to the embodiments in the present invention;

FIG. 6 is a schematic diagram of performing an UPDATE operation for a record of which LUID is 5 between two times of synchronization, according to the embodiments in the present invention;

FIG. 7 is a schematic diagram of corresponding data record items after the UPDATE operation for the record of which LUID is 5 after the operation shown in FIG. 6 between two times of synchronization, according to the embodiments in the present invention;

FIG. 8 is a schematic diagram of corresponding data record items after the DELETE operation for the record of which LUID is 5 after the operation shown in FIG. 7 between two times of synchronization, according to the embodiments in the present invention;

FIG. 9 is a schematic diagram of the changelog after a certain record is deleted as it is invalid between two times of synchronization, according to the embodiments in the present invention;

FIG. 10 is a schematic diagram of an optimized changelog data structure according to the embodiments in the present invention;

FIG. 11 is a schematic diagram of information change using the optimized changelog data structure between two times of synchronization, according to the embodiments in the present invention;

FIG. 12 is a schematic diagram of record items in the changelog before ADD operation according to the embodiments in the present invention;

FIG. 13 is a schematic diagram of record items in the changelog after ADD operation according to the embodiments in the present invention; and

FIG. 14 is a schematic diagram of record items in the changelog after DELETE operation according to the embodiments in the present invention.

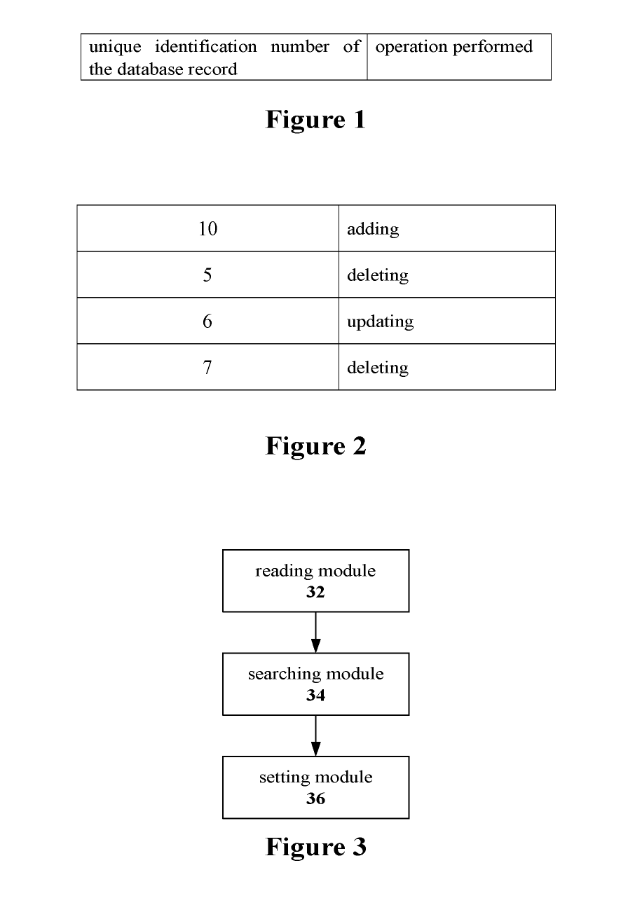

### DETAILED DESCRIPTION OF EMBODIMENTS

Functionality Summary

In the technical solutions provided in the embodiments in the present invention, regarding the problem that there is redundant data in the changelog file as a certain piece of information stored in the mobile phone terminal is modified time after time between two times of synchronization, only the change information in the last time is stored with the technical means of overlapping the latter data record items in the changelog over the former data record items so as to prevent the changelog file from continuously increasing.

In the following embodiments, if not particularly indicated, the changelog is configured to record an operation executed for an object and is composed of data record items, the data record item includes flag information configured to uniquely identify an object, i.e. Locally Unique Identifier (LUID for short), and an operation type corresponding to the flag information, wherein the operation type includes adding (ADD), updating (UPDATE) and deleting (DELETE).

The preferred embodiments of the present invention will be described hereinafter in conjunction with the drawings. It should be understood that the preferred embodiments described herein are merely used to describe and illustrate the present invention without limiting the present invention. The embodiments in the present application and the features therein can be combined with each other if they are not conflicted.

Device Embodiments

A device for maintaining a changelog in data synchronization is provided according to the embodiments in the present invention.

FIG. 3 is a structure block diagram of a device for maintaining a changelog in data synchronization according to the embodiments in the present invention. As shown in FIG. 3, the device comprises a reading module 32, a searching module 34 and a setting module 36. The above structure will be described in detail hereinafter.

The reading module 32 is configured to read, between two times of the data synchronization, the flag information of a first data record item which is required to be added to the changelog;

The searching module 34 is connected to the reading module 32 and is configured to search for whether there is a second data record item including the flag information read by the reading module 32 in the changelog; and

The setting module 36 is connected to the searching module 34 and is configured to set the second data record item according to the first data record item in a situation that the searching result by the searching module 34 is that there is the second data record item.

With this embodiment, the change information for the last time is stored by performing the overlapping process on the data record items including the same flag information, which can thus prevent the changelog file from continuously increasing.

Preferably, the device further comprises a deleting module (not shown in the figure), configured to delete all data record items for which the data synchronization has been performed in the changelog. With this preferred embodiment, all data record items for which the data synchronization has been performed are deleted, and therefore the memory space occupied can be reduced.

Method Embodiments

A method for maintaining a changelog in data synchronization is provided according to the embodiments in the present invention. In this method, the changelog can be set at the mobile terminal side or network side.

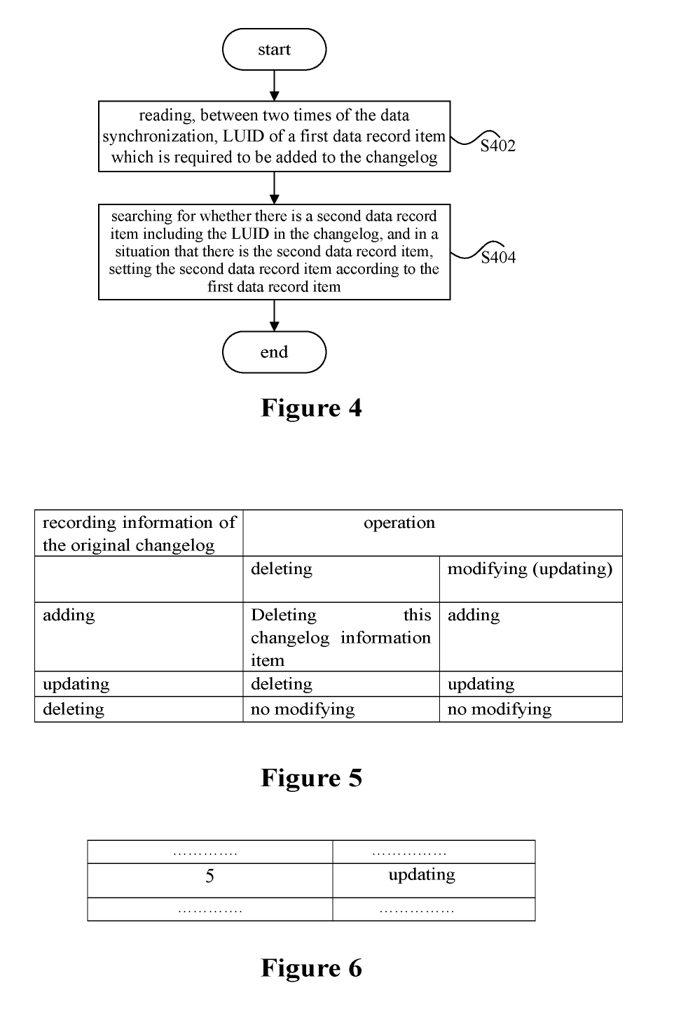

FIG. 4 is a flow chart of the method for maintaining a changelog in data synchronization according to the embodiments in the present invention. As shown in FIG. 4, the method includes:

step S402, reading, between two times of the data synchronization, LUID of a first data record item which is required to be added to the changelog;

step S404, searching for whether there is a second data record item including the LUID in the changelog, and in a situation that there is the second data record item, setting the second data record item according to the first data record item; and in a situation that there is no second data record item, adding the first record item to the changelog and setting an operation type according to an operation corresponding to the first data record item.

With this embodiment, only the change information in the last time is stored with the technical means of overlapping the latter data record items in the changelog over the former data record items, which solves the problem that the changelog file will be increased exceedingly if each time of operation is recorded as a plurality of times of operations may be performed for a certain record between two times of synchronization, therefore, the changelog file can be prevented from increasingly increased.

FIG. 5 is a schematic diagram of information changes in corresponding changelog when the same data record item is modified between two times of synchronization, according to the embodiments in the present invention. As shown in FIG. 5:

in step S404, the step of the operation of setting the second data record item according to the first data record item (i.e. the policy used in modifying the same changelog record) specifically includes the following two situations (41-42):

(41) in a situation that the operation corresponding to the first data record item is DELETE, if the operation type included by the second data record item is ADD (i.e. the existing record is LUID ADD), the second data record item then is deleted, i.e. counterbalance by deleting after adding; and if the operation type included by the second data record item is UPDATE (i.e. the existing record is LUID UPDATE, indicating that the record is updated in the last time), the operation type of the second data record item then is set to be DELETE (i.e. LUID UPDATE is modified to be LUID DELETE). Moreover, it is impossible that the existing record is LUID DELETE since the record that has been deleted cannot be deleted again.

(42) in a situation that the operation corresponding to the first data record item is UPDATE, the operation type included by the second data record item remains unchanged, i.e. if the existing record is LUID ADD, indicating that adding is performed recently, the changelog file then is unchanged; and if the existing record is LUID UPDATE, indicating that updating is performed recently, the changelog file then is unchanged too; moreover, it is impossible that there is LUID DELETE in the changelog file since the updating cannot be performed after the deleting.

In step S404, the step of setting the operation type according to the operation corresponding to the first data record item specifically includes the following three situations (43-45):

(43) if the operation corresponding to the first data record item is ADD, its operation type then is set to be ADD; i.e. when one record is added, the changelog file is added with a record: LUID ADD; this LUID is newly allocated when adding, and theoretically it is impossible that there is already the record of this LUID in the changelog file.

(44) if the operation corresponding to the first data record item is UPDATE, its operation type then is set to be UPDATE, i.e. the changelog file is added with one record: LUID UPDATE.

(45) if the operation corresponding to the first data record item is DELETE, its operation type then is set to be DELETE, i.e. the changelog file is added with one record: LUID DELETE.

Next, the situations of updating the changelog, by performing two times of updating operations successively and one time of deleting operation for the operation of which LUID is 5 between two times of synchronization processes, are described in conjunction with FIGS. 6, 7 and 8.

FIG. 6 shows the UPDATE operation for the record of which LUID is 5 between two times of synchronization process according to the embodiments in the present invention. As shown in FIG. 6, the record of which LUID is 5 is updated for the first time, and as there is no record of which LUID is 5 in the changelog file, the data record item of “5 UPDATE” is added.

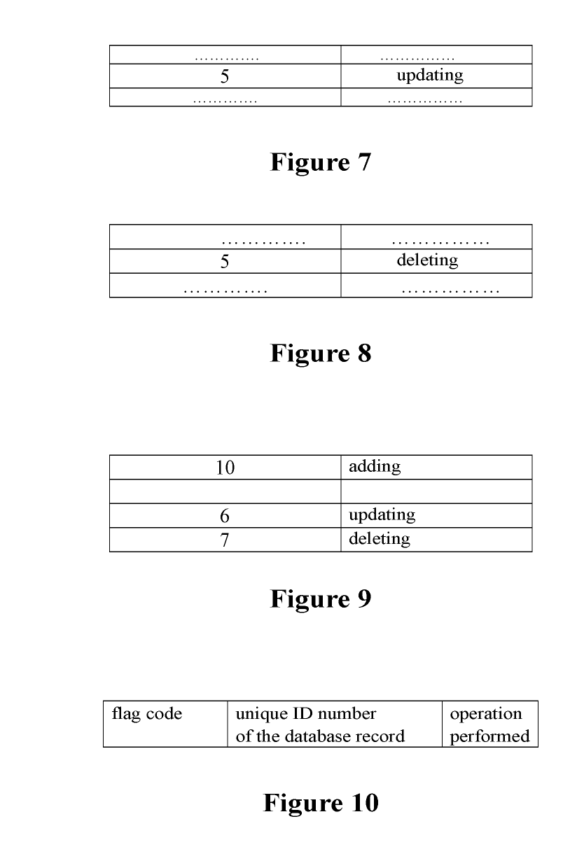

FIG. 7 is a schematic diagram of corresponding data record items after performing the UPDATE operation for the record of which LUID is 5 after the operation as shown in FIG. 6, between two times of synchronization, according to the embodiments in the present invention. As shown in FIG. 7, after the record of which LUID is 5 in the data in the mobile terminal is updated for the second time, it is found that there is the record of which LUID is 5 in the changelog file and the operation is UPDATE, the changelog file then remains unchanged.

FIG. 8 is a schematic diagram of corresponding data record items after the DELETE operation for the record of which LUID is 5 after the operation as shown in FIG. 7, between two times of synchronization, according to the embodiments in the present invention. As shown in FIG. 8, after a deleting operation is performed for the record of which LUID is 5, it is found likewise that there is the record corresponding to the LUID in the changelog file and the operation type is UPDATE, the changelog should change the operation type of the record item corresponding to the LUID into DELETE.

In the precondition of not adding new changelog data record items, this embodiment only stores the information modified in the last time by the overlapping method, so as to reduce the size of the changelog file and save the memory space for the file.

Further, with this embodiment, the size of the changelog file is restricted with a maximum file length of 2*MAXNUM*“size of one record item”, wherein MAXNUM is the number of records supported by the terminal, i.e. the maximum file length is the size of the record items multiplied by the double number of records supported by the terminal, which merely appears in a situation that MAXNUM data are added after MAXNUM data are all deleted.

FIG. 9 is a schematic diagram of the changelog after a certain record is deleted as it is invalid, between two times of synchronization, according to the embodiments in the present invention. As shown in FIG. 9, the blank line is the memory space released by this record. Before this, adding is firstly performed and then the operation of deleting is performed for the record item of which LUID is 5, thus so as to make the record deleted as it is invalid. In this embodiment, the record of which LUID is 5 becomes invalid due to the subsequent operation, therefore, the memory space is released.

In order to enable further optimization of the management and maintenance of the file while preventing the changelog file from continuously increasing and making it easy for the search, the present invention provides a preferred embodiment by adding an flage code FLAG used for identifying whether the data record item is valid or not to the data record items in the changelog, i.e. the above data record item further includes a flag code (FLAG) used for identifying whether the data record item is valid or not.

FIG. 10 is a schematic diagram of an optimized changelog data structure according to the embodiments in the present invention. As shown in FIG. 10, the changelog data structure includes three parts: flag code FLAG, LUID (i.e. unique ID number of the database record), and operation type performed for the record item with the LUID, wherein the flag code has two statuses, namely, valid or invalid. Preferably, “valid” is represented by “1”, and “invalid” is represented by “0”.

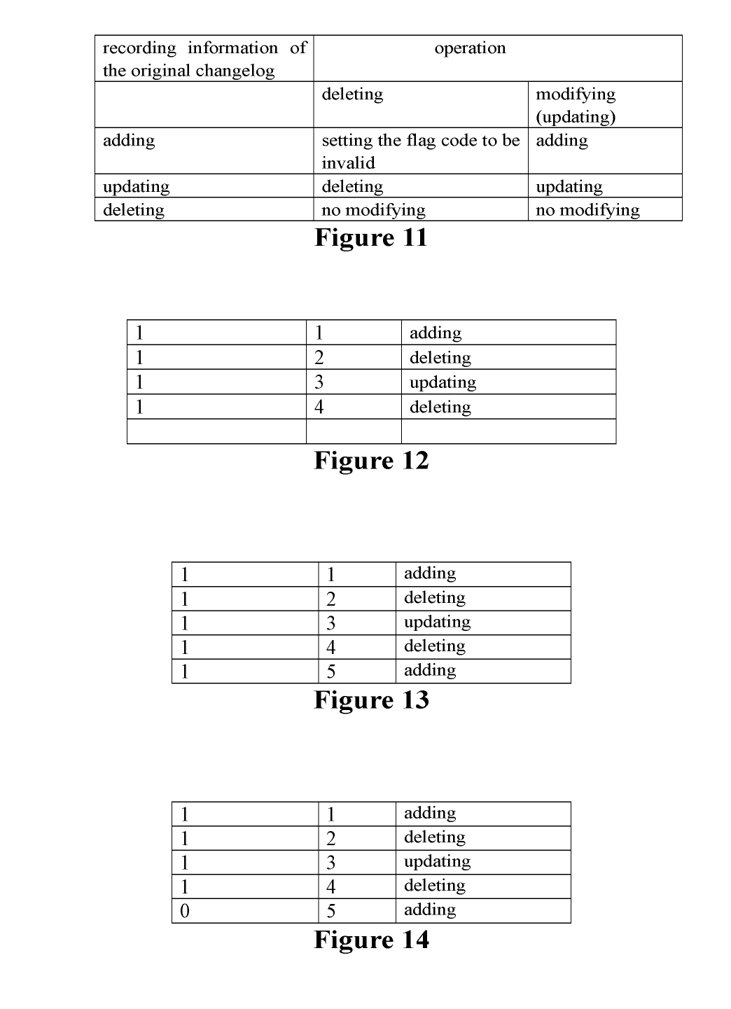

FIG. 11 is a schematic diagram of information change using the optimized changelog data structure, between two times of synchronization, according to the embodiments in the present invention. As for the process of realizing the information change in the changelog in FIG. 5, unnecessary details will not be given herein.

As shown in FIG. 11, regarding the evaluation of the FLAG identifier, the following policy can be used: when a record item with any operation type is newly added to the changelog file, its FLAG identifier becomes valid; and as for the case that the flag code FLAG is invalid, at least two situations are included:

(1) the operation corresponding to the first data record item causes the second data record item to be invalid, i.e. the subsequent operation causes the data record item in the current changelog to be invalid, for instance, the operation corresponding to the first data record item is deleting, and the operation type included by the second data record item is adding, FLAG is set to be invalid, i.e. an operation of performing adding firstly and then deleting for the same LUID, the data record item in the changelog corresponding to this data record item is invalid.

(2) the synchronization process of the data record items in the changelog is completed.

FIG. 12 is a schematic diagram of record items in the changelog before ADD operation according to the embodiments in the present invention. As shown in FIG. 12, the operation type corresponding to the record item of which LUID is 1 is ADD, the operation type corresponding to the record item of which LUID is 2 is DELETE, the operation type corresponding to the record item of which LUID is 3 is UPDATE, the operation type corresponding to the record item of which LUID is 4 is DELETE, and the FLAG identifiers of the above record items are 1.

FIG. 13 is a schematic diagram of record items in the changelog after ADD operation according to the embodiments in the present invention. As shown in FIG. 13, a record item with the operation type of ADD is newly added to the changelog file, i.e. adding “5 ADD”; moreover, as it is a newly added record item, this record is valid and its corresponding FLAG identifier is 1.

FIG. 14 is a schematic diagram of record items in the changelog after DELETE operation according to the embodiments in the present invention. As shown in FIG. 14, after the record item of which LUID is 5 is added, the DELETE operation is also performed for this record between two times of synchronization, thus, this record item is invalid, and its corresponding FLAG identifier is 0. Moreover, in this embodiment, when a certain data record is successfully synchronized, the changelog record corresponding to this data record item is invalid, and its corresponding FLAG identifier is set to be 0.

With this embodiment, when a changelog record item is invalid, updating the changelog record is not to delete this record but to set the FLAG of this data record item to be invalid. Therefore, the complex problem of locating and reusing the spare memory space can be solved according to the FLAG identifiers in the changelog file. The specific process of realizing the same can be accomplished in the following manner:

with the flag code (i.e. FLAG identifier) set in the above data record items and used for identifying whether the data record items are valid or not, after the second data record item is set according to the first data record item, the data record item identified by the flag code to be valid is stored as a new changelog; the new changelog is used to replace the changelog; for instance, all valid changelog records are stored in one temporary file according to the FLAG identifiers; the original changelog file is deleted; and the temporary file is renamed as the name of the original changelog file.

From the above processes, it can be seen that a flag code FLAG used for identifying whether the data record item is valid or not is set, and a completely new changelog file is obtained according to the FLAGE identifier status in the changelog file, thus, the cyclic operations for this changelog file makes it quite easy to maintain the file.

Preferably, all the data record items that complete the data synchronization in the changelog can be deleted; for instance, in a situation that the changelog is set at the mobile terminal side, the mobile terminal deletes all data record items in the changelog after the data synchronization is completed at the mobile terminal and network sides through the changelog. With this preferred embodiment, all the data record items for which the data synchronization has been performed are deleted, thus, the memory space occupied can be reduced.

Owing to the above mentioned, in the embodiments in the present invention:

1. in the precondition of not adding new changelog data record item, only the information modified in the last time is stored with the overlapping method, therefore, the size of the changelog file can be reduced, and the memory space of the file is saved;

2. if the operation corresponding to the data record item required to be added causes the existing data record item to be invalid or after the synchronization of the data record item is successfully compeleted, the corresponding data record item in the changelog is deleted, therefore, the memory space can be saved; and

3. a flag code used for identifying whether the data record item is valid or not is added to the data record items in the changelog, and a completely new changelog file is obtained according to the FLAG identifier status in the changelog file, thus, the cyclic operations for this changelog file makes the complex process of locating and reusing the spare memory space become quite easy, which makes it convenient to maintain the changelog file.

Apparently, the person skilled in the art should know that each module or step in the present invention can be realized by the general calculating apparatus. They can be collected in a single calculating apparatus or distributed in the network formed by a plurality of calculating apparatus. Optionally, they can be realized by the program codes executable by the calculating apparatus, therefore, they can be stored in the storing apparatus to be executed by the calculating apparatus, or they can be fabricated into integrated circuit modules, respectively, or a plurality of modules or steps therein are fabricated into individual integrated circuit module for the accomplishment. Thus, the present invention is not limited to the combination of any particular hardware and software.

Above description is only to illustrate the preferred embodiments but not to limit the present invention. Various alterations and changes to the present invention are apparent to those skilled in the art. The scope defined in claims shall comprise any modification, equivalent substitution and improvement within the spirit and principle of the present invention.

What is claimed is:

1. A method for maintaining a changelog in data synchronization, the changelog being configured to record an operation executed for an object and being composed of data record items, the data record item including flag information configured to uniquely identify the object and an operation type corresponding to the flag information, the operation type including adding, updating and deleting, wherein the method includes:
reading, between two times of the data synchronization, the flag information of a first data record item which is required to be added to the changelog; and
searching for whether there is a second data record item including the flag information in the changelog, and in a situation that there is the second data record item, setting the second data record item according to the first data record item.

2. The method according to claim 1, wherein the step of setting the second data record item according to the first data record item includes:
in a situation that an operation corresponding to the first data record item is deleting, if the operation type included by the second data record item is adding, deleting the second data record item, and if the operation type included by the second data record item is updating, setting the operation type of the second data record item to be deleting; and
in a situation that the operation corresponding to the first data record item is updating, the operation type included by the second data record item remaining unchanged.

3. The method according to claim 1, wherein in a situation that there is no second data record item, the first data record item is added to the changelog, and an operation type is set according to an operation corresponding to the first data record item.

4. The method according to claim 1, wherein the data record item further includes a flag code configured to identify whether the data record item is valid or not.

5. The method according to claim 4, wherein the flag code identifies invalid according to at least either of following two situations:
the operation corresponding to the first data record item causes the second data record item to be invalid; and
a synchronization process of the data record items in the changelog is completed.

6. The method according to claim 5, wherein the situation of the operation corresponding to the first data record item causing the second data record item to be invalid includes:
the operation corresponding to the first data record item being deleting, and the operation type included by the second data record item being adding.

7. The method according to claim 4, wherein after the second data record item is set according to the first data record item, the method further includes:
storing the data record item identified by the flag code to be valid as a new changelog; and
replacing the changelog with the new changelog.

8. The method according to claim 1, wherein the changelog is set at a mobile terminal side or a network side.

9. The method according to claim 8, wherein in a situation that the changelog is set at the mobile terminal side, the method further includes:
after the mobile terminal and the network side complete the data synchronization by means of the changelog, the mobile terminal deleting all data record items in the changelog.

10. A device for maintaining a changelog in data synchronization, the changelog being configured to record an operation executed for an object and being composed of data record items, the data record item including flag information configured to uniquely identify the object and an operation type corresponding to the flag information, the operation type including adding, updating and deleting, wherein the device comprises:
a reading module, configured to, for a first data record item which is required to be added to the changelog, read flag information of the first data record item between two times of the data synchronization;
a searching module, configured to search for whether there is a second data record item including the flag information in the changelog; and
a setting module, configured to set the second data record item according to the first data record item in a situation that a searching result by the searching module is that there is the second data record item.

11. The device according to claim 10, wherein the device further comprises
a deleting module, configured to delete all data record items for which the data synchronization has been performed in the changelog.

12. The method according to claim 2, wherein the changelog is set at a mobile terminal side or a network side.

13. The method according to claim 3, wherein the changelog is set at a mobile terminal side or a network side.

14. The method according to claim 4, wherein the changelog is set at a mobile terminal side or a network side.

15. The method according to claim 5, wherein the changelog is set at a mobile terminal side or a network side.

16. The method according to claim 6, wherein the changelog is set at a mobile terminal side or a network side.

17. The method according to claim 7, wherein the changelog is set at a mobile terminal side or a network side.
